(19) United States
(12) Patent Application Publication
(10) Pub. No.: US 2022/0093302 A1
(43) Pub. Date: Mar. 24, 2022

(54) OPEN-BORE CO-ELECTRODEPOSITION OF METAL MATRIX COMPOSITE COATINGS USING PERMANENT MAGNETS

(71) Applicant: U.S. Army Combat Capabilities Development Command, Army Research Laboratory, Adelphi, MD (US)

(72) Inventors: Heather A. Murdoch, Baltimore, MD (US); Efrain Hernandez, Bel Air, MD (US); Denise Yin, Columbia, MD (US)

(21) Appl. No.: 17/028,081

(22) Filed: Sep. 22, 2020

(51) Int. Cl. H01F 7/02

(52) U.S. Cl. CPC H01F 7/0221; H01F 7/021

(57) ABSTRACT

An apparatus includes an electrochemical cell with an electrolyte solution containing particles and metal ions; an electrode system disposed in the electrolyte solution, wherein the electrode system includes a counter electrode, a reference electrode, and a working electrode, and wherein the counter electrode and the working electrode are arranged to allow electric current to flow therebetween; and an open-bore magnet arrangement having at least one permanent magnet connected to the electrochemical cell and arranged to produce a magnetic field in the electrolyte solution to interact with the electric current to produce an electrodeposition of the particles with metal derived from the metal ions onto the working electrode.

### GOVERNMENT INTEREST

The embodiments herein may be manufactured, used, and/or licensed by or for the United States Government without the payment of royalties thereon.

### BACKGROUND

### Technical Field

The embodiments herein generally relate to electrodeposition technologies, and more particularly to electrochemical and magnetic systems used for performing electrodeposition.

### Description of the Related Art

Compared to other processing techniques, electrodeposition is a fast, economical, and versatile approach to manufacturing composite coatings. The incorporation of particles into the growing metal matrix is common practice for improving deposit properties like wear and corrosion resistance. Several challenges, however, have set severe limits on the full realization of controlled composite coatings. Particle agglomeration and sedimentation, for instance, prevents having an even dispersion in the electrolyte and subsequently produces non-uniform coatings. To mitigate this, quality coatings have often been aided by additives like surfactants, alternative electrolytes like deep eutectic solvents, particular current waveforms like reverse pulse plating, and additional processing techniques like bath agitation. These plating strategies, however, often have drawbacks that influence the coating and/or the coating process in a negative way.

Magnetic fields are a less-invasive approach and have also been shown to supplement particle incorporation and distribution by inducing additional convective stirring (“magnetohydrodynamic” flow), which—given sufficiently high applied currents and/or magnetic strengths—can induce magnetic stirring of the electrolyte. This additional stirring can improve particle incorporation but has only been demonstrated thus far in rather small (<1 cm) electrochemical cells set in the bore of an electromagnet that typically produces high magnetic flux densities (>10 T).

While electromagnets offer users the versatility to turn on and off the field with the flick of a switch, as well as to easily adjust the magnetic strength during operation, they are typically set up in complicated systems requiring a constant (power) supply of electric current and circulating water for cooling and removal of waste heat, thus incurring significant energy consumption. These concerns become significant for scale-up considerations as economic feasibility decreases with increasing system size. Additionally, spatial dimensions dictate that the size of the electrochemical cell is limited entirely by the size of the bore, which would make coating of larger parts and/or unconventional geometries virtually impossible.

Investigations into electrodeposited metal matrix composites are becoming more prevalent as emerging technologies, particularly in aerospace and automotive environments, require more advanced materials. Particle-incorporated coatings offer promising improvements in tribology and wear resistance, as well as lubrication and corrosion protection. Many strategies are used in electrodeposition to introduce particles to coatings but are often disadvantaged with drawbacks to the coating and/or coating process itself. As described above, and as an alternative, magnetic fields have been shown to be a promising noninvasive approach; however, electrochemical cells in studies thus far have been set in the bore of a small electromagnet, typically placing restrictions on system size. As mentioned, generally such a set-up has spatial limitations, is complicated, requires high energy consumption for operation, and thus may not be advantageously primed for industrial scale-up.

### SUMMARY

In view of the foregoing, an embodiment herein provides an electrochemical system comprising an electrochemical cell comprising an electrolyte solution containing particles; an electrode system positioned in the electrochemical cell, wherein the electrode system comprises a counter electrode, a reference electrode, and a working electrode; and an open-bore magnet arrangement comprising a permanent magnet contacting the electrochemical cell. The permanent magnet may be positioned inside of the electrochemical cell. Moreover, the permanent magnet may be positioned outside of the electrochemical cell. The particles may be magnetic. Furthermore, the particles may be non-magnetic. Additionally, the particles may comprise Eu-doped yttria. The permanent magnet may produce a magnetic field of less than 1 Tesla. More particularly, the permanent magnet may produce a magnetic field of approximately 0.25 Tesla. The permanent magnet may comprise a rare-earth magnet.

Another embodiment provides an apparatus comprising an electrochemical cell comprising an electrolyte solution containing particles and metal ions; an electrode system disposed in the electrolyte solution, wherein the electrode system comprises a counter electrode, a reference electrode, and a working electrode, and wherein the counter electrode and the working electrode are arranged to allow electric current to flow therebetween; and an open-bore magnet arrangement comprising at least one permanent magnet connected to the electrochemical cell and arranged to produce a magnetic field in the electrolyte solution to interact with the electric current to produce an electrodeposition of the particles with metal derived from the metal ions onto the working electrode.

The at least one permanent magnet may be positioned behind the working electrode, and wherein the at least one permanent magnet is positioned parallel to the electric current. The at least one permanent magnet may be positioned perpendicular to the electric current. The at least one permanent magnet may comprise a pair of permanent magnets. The pair of permanent magnets may be positioned parallel to the electric current. The pair of permanent magnets may be positioned perpendicular to the electric current. The pair of permanent magnets may be each positioned at 45° angles with respect to the working electrode.

Another embodiment provides a method of performing electrodeposition of a metal coating containing particles, the method comprising providing an electrochemical cell comprising an electrolyte solution containing particles and metal ions; arranging an electrode system in the electrochemical cell, wherein the electrode system comprises a counter electrode, a reference electrode, and a working electrode; connecting the electrochemical cell to an open-bore magnet arrangement comprising at least one permanent magnet; establishing a magnetic field, by the at least one permanent magnet, in the electrolyte solution; passing an electric current between the counter electrode and the working electrode; and producing movement of the particles in the electrolyte solution, through interaction of the magnetic field and the electric current, to produce an electrodeposition of the particles with metal derived from the metal ions onto the working electrode. The electric current may comprise a current density of approximately 50 mA/cm². The method may comprise stirring the electrolyte solution during the electrodeposition using a non-magnetic stirrer. The method may comprise arranging the at least one permanent magnet at a selected angle with respect to a flow of the electric current to maximize a Lorentz force applied to the particles.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A is a schematic diagram illustrating a perspective view of an electrochemical system with a permanent magnet arranged inside the electrochemical cell, according to an embodiment herein;

FIG. 1B is a schematic diagram illustrating a top view of the electrochemical system of FIG. 1A, according to an embodiment herein;

FIG. 2A is a schematic diagram illustrating a perspective view of an electrochemical system with a permanent magnet arranged outside the electrochemical cell, according to an embodiment herein;

FIG. 2B is a schematic diagram illustrating a top view of the electrochemical system of FIG. 2A, according to an embodiment herein;

FIG. 3 is a schematic diagram illustrating a magnetic field produced by the permanent magnet of the electrochemical system of FIGS. 1A through 2B, according to an embodiment herein;

FIG. 4 is a schematic diagram illustrating a perspective view of an electrodeposition apparatus, according to an embodiment herein;

FIG. 5 is a schematic diagram illustrating a perspective view of the electrodeposition apparatus of FIG. 4 with a non-magnetic stirrer, according to an embodiment herein;

FIG. 6A is a schematic diagram illustrating an electrochemical system with a current between two magnets;

FIG. 6B is a schematic diagram illustrating an electrochemical system with a current between two magnets and a permanent magnet positioned to be parallel to the current, according to an embodiment herein;

FIG. 6C is a schematic diagram illustrating an electrochemical system with a current between two magnets and a pair of permanent magnets positioned to be parallel to the current, according to an embodiment herein;

FIG. 6D is a schematic diagram illustrating an electrochemical system with a current between two magnets and a permanent magnet positioned to be perpendicular to the current, according to an embodiment herein;

FIG. 6E is a schematic diagram illustrating an electrochemical system with a current between two magnets and a pair of permanent magnets positioned to be perpendicular to the current density, according to an embodiment herein;

FIG. 6F is a schematic diagram illustrating an electrochemical system with a current between two magnets and a pair of permanent magnets positioned to be 45° to the current density and working electrode, according to an embodiment herein;

FIG. 7A is a flow diagram illustrating a method of performing electrodeposition of particles, according to an embodiment herein;

FIG. 7B is a flow diagram illustrating a method of stirring an electrolyte solution in an electrochemical system for performing an electrodeposition process, according to an embodiment herein; and

FIG. 7C is a flow diagram illustrating a method of arranging at least one permanent magnet in an electrochemical system for performing an electrodeposition process, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

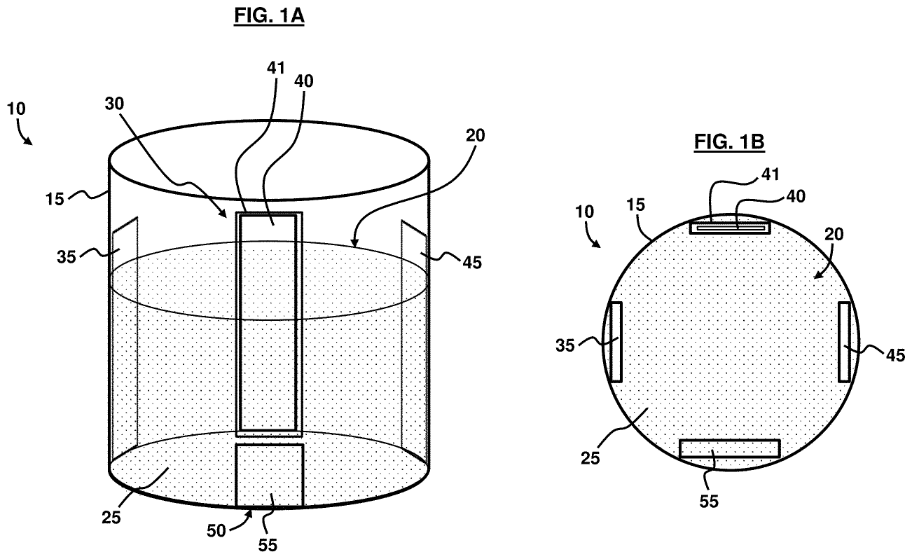

The embodiments herein provide an electrodeposition technique that uses permanent magnets in an open-bore arrangement instead of using conventional electromagnets. This increases experimental versatility (e.g., the permanent magnet can be placed in or outside the electrolyte, and is more primed for large-scale processing). Furthermore, the embodiments herein achieve lower operating costs (i.e., does not require continuous supply of electrical energy or water cooling to the source of the magnetic field). Moreover, the techniques provided by the embodiments herein require less maintenance (e.g., no damage from short circuits as there is with electromagnets), require only minimal field strengths (−0.25 T), and are able to incorporate non-magnetic (vs. magnetic) particles. Referring now to the drawings, and more particularly to FIGS. 1A through 7C, where similar reference characters denote corresponding features consistently throughout the figures, there are shown preferred embodiments. In the drawings, the size and relative sizes of components, layers, and regions, etc. may be exaggerated for clarity.

FIGS. 1A and 1B illustrate an electrochemical system 10 comprising an electrochemical cell 15 comprising an electrolyte solution 20 containing particles 25. According to some examples, the electrochemical cell 15 may be constructed as a glass or polymer container of any suitable size, shape, and configuration. For example, the electrochemical cell 15 may comprise a glass beaker. In an example, the electrolyte solution 20 may be an aqueous, metal salt solution that permits the flow of electricity in the electrolyte solution 20, and the particles 25 may be metal salts. For example, the electrolyte solution 20 may comprise a Watts bath containing nickel sulfate (NiSO₄6H₂O), nickel chloride (NiCl₂6H₂O), and boric acid (H₃BO₃), and may be kept at an approximate temperature between 40-65° C., and at an approximate pH between 4.7-5.1. According to an example, the electrolyte solution 20 may contain 300 g/L NiSO₄, 45 g/L NiCl₂, and 30 g/L H₃BO₃ along with 1 g/L of Europium-doped Y₂O₃ (with stoichiometry Y_{1.92}Eu_{0.08}O₃). In an example, the particles 25 may be magnetic. In another example, the particles 25 may be non-magnetic. According to another example, the particles 25 may comprise Eu-doped yttria.

The electrochemical system 10 further comprises an electrode system 30 positioned in the electrochemical cell 15. In an example, the electrode system 30 may be a two-electrode system or a three-electrode system. However, the embodiments herein are not restricted to any particular type of electrode system. According to an example, the electrode system 30 comprises a counter electrode 35, a reference electrode 40, and a working electrode 45, which are arranged in the electrochemical cell 15 and are partially or completely disposed in the electrolyte solution 20. In an example, the electrode system 30 may be arranged to position the counter electrode 35 to be diametrically opposed to the working electrode 45, and with the reference electrode 40 positioned between the counter electrode 35 and the working electrode 45 without interfering with the electrical path between the counter electrode 35 and the working electrode 45. In an example, the reference electrode 40 may be positioned inside a separate chamber or tube 41 that is inserted in the electrochemical cell 15. A voltage source (not shown) may be connected to the electrode system 30 to supply voltage between the reference electrode 40 and the working electrode 45. While not shown in the drawings, the electrode system 30 may be electrically connected using wire. Additionally, while not shown in the drawings, a temperature probe may be inserted in the electrochemical cell 15 to measure the temperature of the electrolyte solution 20 during an electrodeposition process.

The counter electrode 35 may be composed of a conductive material including metals such as gold, silver, copper, nickel, platinum, or graphite, among other suitable materials. In an example, the counter electrode 35 may serve as the anode in the electrode system 30, and the counter electrode 35 may pass current i through the electrolyte solution 20 to the working electrode 45. In this example, the working electrode 45 may serve as the cathode in the electrode system 30 where the metal from the particles 25 are deposited. The working electrode 45 may be composed of a conductive material including metals such as gold, silver, copper, nickel, platinum, or graphite, among other suitable materials. The reference electrode 40 may be used to measure the electrode potential of the working electrode 45 by measuring the electrode potential in the electrolyte solution 20, typically at the location where the reference electrode 40 is positioned in the electrolyte solution 20. The amount of the electrode potential of the working electrode 45 may be controlled by adjusting the amount of voltage applied to the working electrode 45. Some examples of the reference electrode 40 may include a saturated calomel (Hg₂Cl₂) electrode, silver/silver chloride (Ag/AgCl) electrode, mercury/mercurous sulfate (Hg/Hg₂SO₄) electrode, and a mercury/mercury oxide (Hg/HgO) electrode, among others.

The electrochemical system 10 further comprises an open-bore magnet arrangement 50 comprising a permanent magnet 55 contacting the electrochemical cell 15. In an example, the permanent magnet 55 may comprise a rare-earth magnet. In some examples, the permanent magnet 55 may comprise neodymium (Nd₂Fe₁₄B) or samarium-cobalt (SmCo₅) rare-earth magnets, among other types. Although the permanent magnet 55 may have a higher unit cost than conventional electromagnets, the dimensions of the electrochemical cell 15 are not limited by the size of the permanent magnet 55, thus the permanent magnet 55 does not have to scaled up as much as a conventional electromagnet does to enable processing on a larger scale; i.e., it may be possible to use multiple small, lower-cost permanent magnets 55 to affect particle incorporation in larger parts during the electrodeposition process. As such, the use of the permanent magnet 55 eliminates the complicated system requirements and power consumption necessary for conventional electromagnets and therefore the permanent magnet 55 offers greater flexibility when it comes to accommodating transitions from lab-scale to full-scale operations for performing the electrodeposition process.

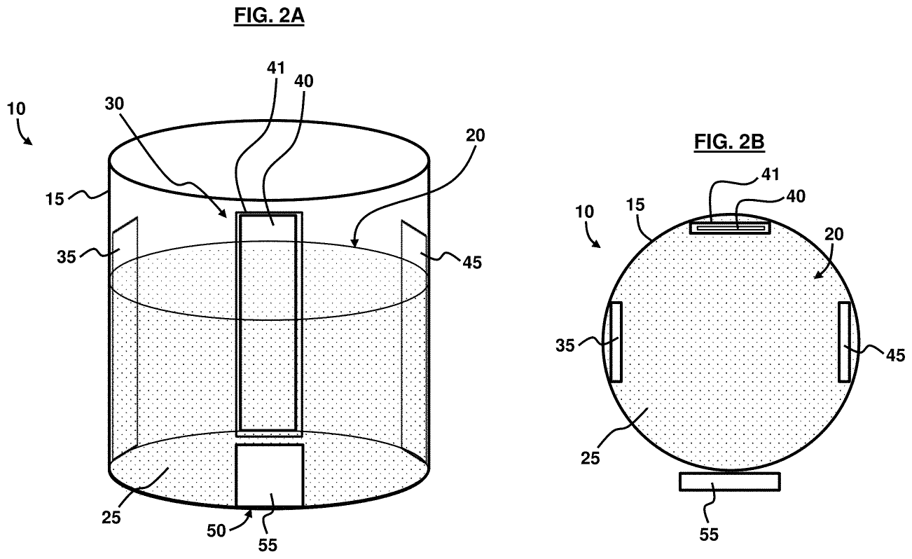

As shown in FIGS. 1A and 1B, the permanent magnet 55 may be positioned inside of the electrochemical cell 15 and is partially or completely disposed in the electrolyte solution 20. Alternatively, as shown in FIGS. 2A and 2B, with reference to FIGS. 1A and 1B, the permanent magnet 55 may be positioned outside of the electrochemical cell 15. In other arrangements, the permanent magnet 55 may be part of a larger magnet system containing a plurality of magnets such that the magnets may be positioned inside or outside the electrochemical cell 15, including a combination of inside positions for some of the magnets and outside positions for some of the other magnets in the same overall magnet system. Accordingly, the permanent magnet 55 can be used in an open-bore set-up such that the permanent magnet 55 can be placed either inside or outside the electrolyte solution 20 (e.g., affixed to the inside or outside of the electrochemical cell 15) unlike conventional electromagnets which can only surround an electrochemical cell (e.g., outside the electrolyte solution).

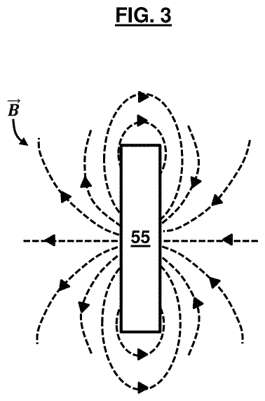

As shown in FIG. 3, with reference to FIGS. 1A through 2B, the permanent magnet 55 may produce a magnetic field \vec{B}. In an example, the permanent magnet 55 may produce a magnetic field \vec{B} of less than 1 Tesla. More particularly, the permanent magnet 55 may produce a magnetic field \vec{B} of approximately 0.25 Tesla, according to an example. Instead of conventional electromagnets, the permanent magnet 55 is much more conducive to industrialization of magnetic field-enabled electrodeposition. Accordingly, the embodiments herein demonstrate that the permanent magnet 55 can improve particle incorporation with fields as low as 0.25 Tesla.

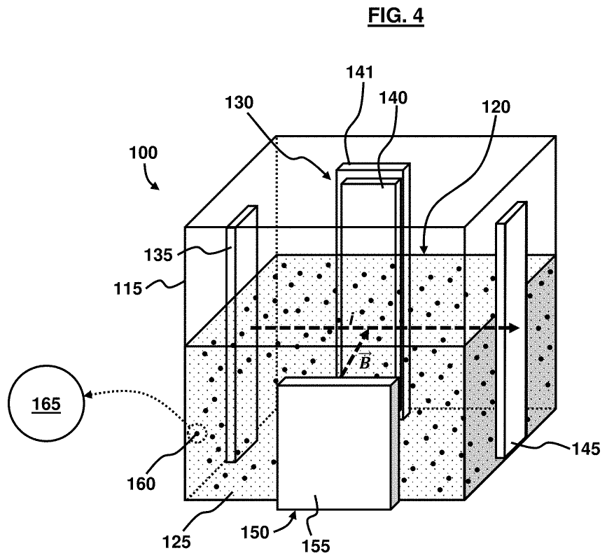

FIG. 4, with reference to FIGS. 1A through 3, illustrates an apparatus 100 comprising an electrochemical cell 115 comprising an electrolyte solution 120 containing particles 125 and metal ions 160. According to some examples, the electrochemical cell 115 may be constructed as a glass or polymer container of any suitable size, shape, and configuration. For example, the electrochemical cell 115 may comprise a glass box. In an example, the electrolyte solution 120 may be an aqueous, metal salt solution that permits the flow of electricity in the electrolyte solution 120, and the particles 125 may be metal salts. For example, the electrolyte solution 120 may comprise a Watts bath containing nickel sulfate (NiSO₄6H₂O), nickel chloride (NiCl₂₆H₂O), and boric acid (H₃BO₃), and may be kept at an approximate temperature between 40-65° C., and at an approximate pH between 4.7-5.1. According to an example, the electrolyte solution 120 may contain 300 g/L NiSO₄, 45 g/L NiCl₂, and 30 g/L H₃BO₃ along with 1 g/L of Europium-doped Y₂O₃ (with stoichiometry Y_{1.92}Eu_{0.08}O₃). In an example, the particles 125 may be magnetic. In another example, the particles 125 may be non-magnetic. According to another example, the particles 125 may comprise Eu-doped yttria.

The apparatus 100 further comprises an electrode system 130 disposed in the electrolyte solution 120, wherein the electrode system 130 comprises a counter electrode 135, a reference electrode 140, and a working electrode 145. In an example, the electrode system 130 may be a two-electrode system or a three-electrode system. However, the embodiments herein are not restricted to any particular type of electrode system. According to an example, the electrode system 130 comprises a counter electrode 135, a reference electrode 140, and a working electrode 145, which are arranged in the electrochemical cell 115 and are partially or completely disposed in the electrolyte solution 120. The counter electrode 135 and the working electrode 145 are arranged to allow electric current i to flow therebetween.

In an example, the electrode system 130 may be arranged to position the counter electrode 135 to be diametrically opposed to the working electrode 145, and with the reference electrode 40 positioned between the counter electrode 135 and the working electrode 145 without interfering with the electrical path between the counter electrode 135 and the working electrode 145. In an example, the reference electrode 140 may be positioned inside a separate chamber or tube 141 that is inserted in the electrochemical cell 115. A voltage source (not shown) may be connected to the electrode system 130 to supply voltage between the reference electrode 140 and the working electrode 145. While not shown in the drawings, the electrode system 130 may be electrically connected using wire. Additionally, while not shown in the drawings, a temperature probe may be inserted in the electrochemical cell 115 to measure the temperature of the electrolyte solution 120 during an electrodeposition process.

The counter electrode 135 may be composed of a conductive material including metals such as gold, silver, copper, nickel, platinum, or graphite, among other suitable materials. In an example, the counter electrode 135 may serve as the anode in the electrode system 130, and the counter electrode 135 may pass current i through the electrolyte solution 120 to the working electrode 145. In this example, the working electrode 145 may serve as the cathode in the electrode system 130 where the metal from the particles 125 are deposited. The working electrode 145 may be composed of a conductive material including metals such as gold, silver, copper, nickel, platinum, or graphite, among other suitable materials. The reference electrode 140 may be used to measure the electrode potential of the working electrode 145 by measuring the electrode potential in the electrolyte solution 120, typically at the location where the reference electrode 140 is positioned in the electrolyte solution 120. The amount of the electrode potential of the working electrode 145 may be controlled by adjusting the amount of voltage applied to the working electrode 145. Some examples of the reference electrode 140 may include a saturated calomel (Hg₂Cl₂) electrode, silver/silver chloride (Ag/AgCl) electrode, mercury/mercurous sulfate (Hg/Hg₂SO₄) electrode, and a mercury/mercury oxide (Hg/HgO) electrode, among others.

The apparatus 100 further comprises an open-bore magnet arrangement 150 comprising at least one permanent magnet 155 connected to the electrochemical cell 115 and arranged to produce a magnetic field \vec{B} in the electrolyte solution 120 to interact with the electric current i to produce an electrodeposition of the particles 125 with metal 165 derived from the metal ions 160 onto the working electrode 145. In an example, the metal 165 may comprise nickel. According to an example, the at least one permanent magnet 155 may comprise a rare-earth magnet. In some examples, the at least one permanent magnet 155 may comprise neodymium (Nd₂Fe₁₄B) or samarium-cobalt (SmCo₅) rare-earth magnets, among other types. While FIG. 4 shows the at least one permanent magnet 155 is positioned outside the electrochemical cell 115, the at least one permanent magnet 155 may be positioned either outside or inside the electrochemical cell 115 in accordance with the embodiments herein.

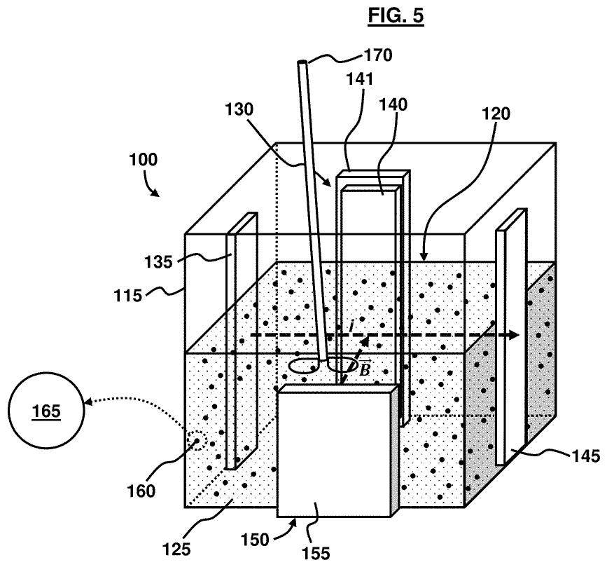

FIG. 5, with reference to FIGS. 1A through 4, illustrates that in an example, during the electrodeposition process the electrolyte solution 120 may be stirred using a non-magnetic stirrer 170. For example, the non-magnetic stirrer 170 may comprise glass. The non-magnetic stirrer 170 may be used since a magnetic stir bar could interfere with the magnetic field \vec{B}.

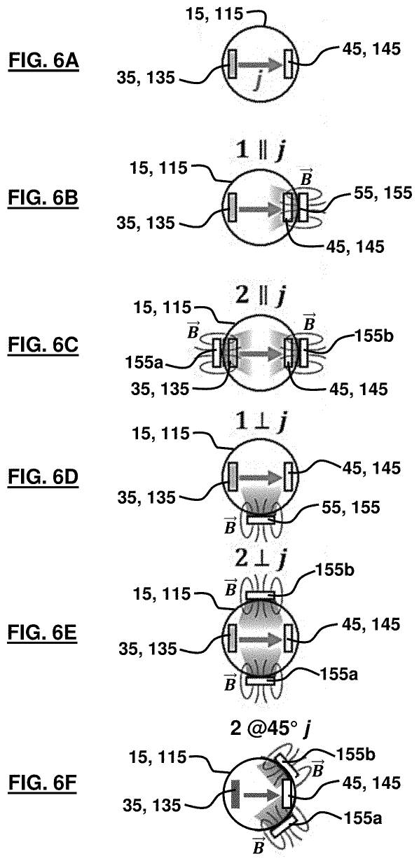

FIGS. 6A through 6F, with reference to FIGS. 1A through 5, are schematic diagrams illustrating multiple arrangements of the at least one permanent magnet 55, 155, the counter electrode 35, 135, and the working electrode 45, 145. According to an example, the at least one permanent magnet 155 may comprise a pair of permanent magnets 155a, 155b. As shown in FIG. 6A, the electric current i, which is passed from the counter electrode 35, 135 to the working electrode 45, 145, may comprise a current density j. In an example, the current density j may be approximately between 2-10 A/dm².

As shown in FIG. 6B, the permanent magnet 55, 155 may be positioned behind the working electrode 45, 145, and the magnet 55, 155 is positioned parallel to the electric current i (and current density j). As shown in FIG. 6C, the pair of permanent magnets 155a, 155b may be positioned parallel to the electric current i (and current density j) such that permanent magnet 155a is positioned behind the counter electrode 35, 135, and the permanent magnet 155b is positioned behind the working electrode 45, 145. As shown in FIG. 6D, the permanent magnet 55, 155 may be positioned perpendicular to the electric current i (and current density j). As shown in FIG. 6E, the pair of permanent magnets 155a, 155b may each be positioned perpendicular to the electric current i (and current density j). As shown in FIG. 6F, the pair of permanent magnets 155a, 155b may be each positioned at 45° angles with respect to the electric current i (and current density j) and the working electrode 45, 145. The magnetic field B may supplement particle incorporation and distribution by inducing additional convective stirring (“magnetohydrodynamic” flow), that forms from the Lorentz force, F_{L}, which describes the interaction between the applied current, i, and magnetic field, \vec{B}, as in F_{L}=i×\vec{B}. Based on this cross product, the Lorentz force, F_{L}, is maximized in the perpendicular arrangements of the magnet(s) 55, 155, 155a, 155b, as shown in FIGS. 6D and 6E.

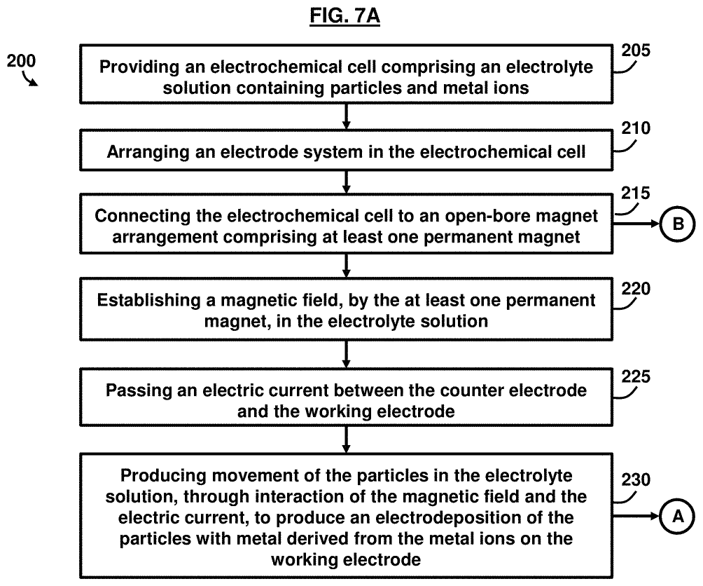

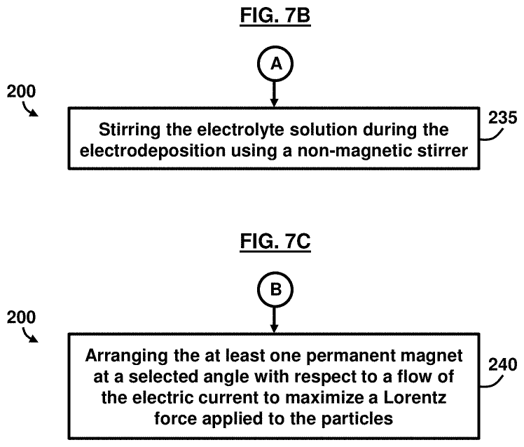

FIGS. 7A through 7C, with reference to FIGS. 1A through 6F, is a flow diagram of a method 200 of performing electrodeposition of particles 25, 125. As shown in FIG. 6A, the method 200 comprises providing (205) an electrochemical cell 15, 150 comprising an electrolyte solution 20, 120 containing particles 25, 125 and metal ions 160; arranging (210) an electrode system 30, 130 in the electrochemical cell 15, 150, wherein the electrode system 30, 130 comprises a counter electrode 35, 135, a reference electrode 40, 140, and a working electrode 45, 145; connecting (215) the electrochemical cell 15, 150 to an open-bore magnet arrangement 50, 150 comprising at least one permanent magnet 55, 155; establishing (220) a magnetic field id, by the at least one permanent magnet 55, 155, in the electrolyte solution 20, 120; passing (225) an electric current i between the counter electrode 35, 135 and the working electrode 45, 145; and producing (230) movement of the particles 25, 125 in the electrolyte solution 20, 120, through interaction of the magnetic field B and the electric current i, to produce an electrodeposition of the particles 25, 125 with metal 165 derived from the metal ions 160 onto the working electrode 45, 145. In an example, the electric current i may comprise a current density j of approximately 50 mA/cm². As shown in FIG. 7B, the method 200 may comprise stirring (235) the electrolyte solution 20, 120 during the electrodeposition using a non-magnetic stirrer 170. As shown in FIG. 7C, the method 200 may comprise arranging (240) the at least one permanent magnet 55, 155 at a selected angle with respect to a flow of the electric current i to maximize a Lorentz force, F_{L}, applied to the particles 25, 125. According to an example, the selected angle may be between 1-180°.

The embodiments herein may be utilized for several different types of applications, including, but not limited to, thermal management for aircraft using vanadium oxide-embedded coatings, health monitoring of coatings co-electrodeposited with phosphorescing/luminescent particles, wear resistant tool facings, cutting tools, automotive engines that require wear resistance and improved lubrication (e.g., in high performance internal combustion cylinder liners), coatings for corrosion protection (e.g., sacrificial Zn-ceramic coatings on steel, metal-PTFE coatings), and Ni-graphite as 1) thin film battery electrodes for consumer electronics and 2) bipolar plates in polymer electrolyte membrane (PEM) fuel cells.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. An electrochemical system comprising:
an electrochemical cell comprising an electrolyte solution containing particles;
an electrode system positioned in the electrochemical cell, wherein the electrode system comprises a counter electrode, a reference electrode, and a working electrode; and
an open-bore magnet arrangement comprising a permanent magnet contacting the electrochemical cell.

2. The electrochemical system of claim 1, wherein the permanent magnet is positioned inside of the electrochemical cell.

3. The electrochemical system of claim 1, wherein the permanent magnet is positioned outside of the electrochemical cell.

4. The electrochemical system of claim 1, wherein the particles are magnetic.

5. The electrochemical system of claim 1, wherein the particles are non-magnetic.

6. The electrochemical system of claim 1, wherein the particles comprise Eu-doped yttria.

7. The electrochemical system of claim 1, wherein the permanent magnet produces a magnetic field of less than 1 Tesla.

8. The electrochemical system of claim 1, wherein the permanent magnet produces a magnetic field of approximately 0.25 Tesla.

9. The electrochemical system of claim 1, wherein the permanent magnet comprises a rare-earth magnet.

10. An apparatus comprising:
an electrochemical cell comprising an electrolyte solution containing particles and metal ions;
an electrode system disposed in the electrolyte solution, wherein the electrode system comprises a counter electrode, a reference electrode, and a working electrode, and wherein the counter electrode and the working electrode are arranged to allow electric current to flow therebetween; and
an open-bore magnet arrangement comprising at least one permanent magnet connected to the electrochemical cell and arranged to produce a magnetic field in the electrolyte solution to interact with the electric current to produce an electrodeposition of the particles with metal derived from the metal ions onto the working electrode.

11. The apparatus of claim 10, wherein the at least one permanent magnet is positioned behind the working electrode, and wherein the at least one permanent magnet is positioned parallel to the electric current.

12. The apparatus of claim 10, wherein the at least one permanent magnet is positioned perpendicular to the electric current.

13. The apparatus of claim 10, wherein the at least one permanent magnet comprises a pair of permanent magnets.

14. The apparatus of claim 13, wherein the pair of permanent magnets are positioned parallel to the electric current.

15. The apparatus of claim 13, wherein the pair of permanent magnets are positioned perpendicular to the electric current.

16. The apparatus of claim 13, wherein the pair of permanent magnets are each positioned at 45° angles with respect to the working electrode.

17. A method of performing electrodeposition of particles, the method comprising:
providing an electrochemical cell comprising an electrolyte solution containing particles and metal ions;
arranging an electrode system in the electrochemical cell, wherein the electrode system comprises a counter electrode, a reference electrode, and a working electrode;
connecting the electrochemical cell to an open-bore magnet arrangement comprising at least one permanent magnet;
establishing a magnetic field, by the at least one permanent magnet, in the electrolyte solution;
passing an electric current between the counter electrode and the working electrode; and
producing movement of the particles in the electrolyte solution, through interaction of the magnetic field and the electric current, to produce an electrodeposition of the particles with metal derived from the metal ions onto the working electrode.

18. The method of claim 17, wherein the electric current comprises a current density of approximately 50 mA/cm².

19. The method of claim 17, comprising stirring the electrolyte solution during the electrodeposition using a non-magnetic stirrer.

20. The method of claim 17, comprising arranging the at least one permanent magnet at a selected angle with respect to a flow of the electric current to maximize a Lorentz force applied to the particles.
